(19) United States
(12) Patent Application Publication
(10) Pub. No.: US 2003/0226341 A1
(43) Pub. Date: Dec. 11, 2003

(54) AN ASSEMBLY FOR PERFORMING CROP HARVESTING

(75) Inventors: Franciscus Johannes Adrianus DE GROEN, Hellevoetsluis (NL); Alexander van der LELY, Rotterdam (NL)

Correspondence Address: HOWREY SIMON ARNOLD & WHITE, CITYPOINT, ONE ROPEMAKER STREET, LONDON, EC2Y 9HS, GB

(73) Assignee: LELY ENTERPRISES AG, Zug (NL)

(21) Appl. No.: 10/250,126

(22) Filed: Jun. 5, 2003

(30) Foreign Application Priority Data
Jun. 6, 2002 (NL) 1020802

(51) Int. Cl. A01D 75/28

(52) U.S. Cl. 56/10.2 R

(57) ABSTRACT

An assembly for performing a crop harvesting operation. The device is provided with an autonomous harvesting machine that is movable over a parcel for performing the crop harvesting operation, the autonomous harvesting machine being provided with a machine container for containing a first amount of harvested product, and with a harvest container for containing the harvested product. The assembly is provided with a measuring device for measuring the amount of product in the machine container and with a control unit for automatically moving the harvesting machine to the harvest container with the aid of data from the measuring device. A device for baling. The device is an autonomous baler that is movable over a parcel. A device for chopping crop. The device is an autonomous chopper that is movable over a parcel.

### CROSS REFERENCE TO RELATED APPLICATIONS

This application claims priority from Dutch patent application no. 1020802 filed Jun. 6, 2002, the contents of which are hereby incorporated by reference in their entirety.

### BACKGROUND OF INVENTION

1. Field of the Invention

The invention relates to the field of agriculture and more particularly to an assembly for performing a crop harvesting operation.

2. Description of the Related Art

Crop harvesting devices are known, which require human operators. Autonomous crop harvesters are also known, which can operate without direct human intervention. Such autonomous harvesters have substantial limitations. The invention aims at providing an alternative assembly for performing a crop harvesting operation.

### SUMMARY OF INVENTION

According to the present invention, for this purpose an assembly for performing a crop harvesting operation comprises an autonomous harvesting machine that is movable over a parcel for performing the crop harvesting operation, the harvesting machine comprising a machine container for containing a first amount of harvested product, a harvest container for containing the harvested product, a measuring device for measuring the amount of product in the machine container and a control unit for automatically moving the harvesting machine to the harvest container with the aid of data from the measuring device. This makes it possible for example to move the autonomous harvesting machine to the harvest container depending on the measured amount. Due to the fact that the autonomous harvesting machine automatically conveys the harvested product (for example grass) to the harvest container, the assembly can continue to work automatically for a long time.

For the purpose of moving the autonomous harvesting machine in a simple manner to the storage container, it is advantageous if the control unit is provided with a route information system for containing position information about the harvest container. The assembly is in particular provided with a position-determining system for determining the momentary position of the harvesting machine.

As the crop subjected to the harvesting operation is preferably processed further, it is advantageous if the harvesting machine is provided with means for making the harvested crop on which the harvesting operation has been performed ready for transport. It is in particular advantageous if the harvesting machine is provided with means for making the harvested crop on which the harvesting operation has been performed ready for storage. Such a processing device may for example chop, press, wrap, dry (or carry out similar treatments on) the harvested product. The harvesting machine comprises in particular a crop pick-up device and/or a mowing unit.

The invention also relates to an autonomous baler and an autonomous chopper.

### BRIEF DESCRIPTION OF DRAWINGS

An embodiment of the invention will now be explained in further detail by way of example only with reference to the accompanying figures, in which:

FIG. 1 shows schematically in plan view an autonomous harvesting machine in an agricultural parcel in an embodiment of an assembly according to the invention.

### DETAILED DESCRIPTION

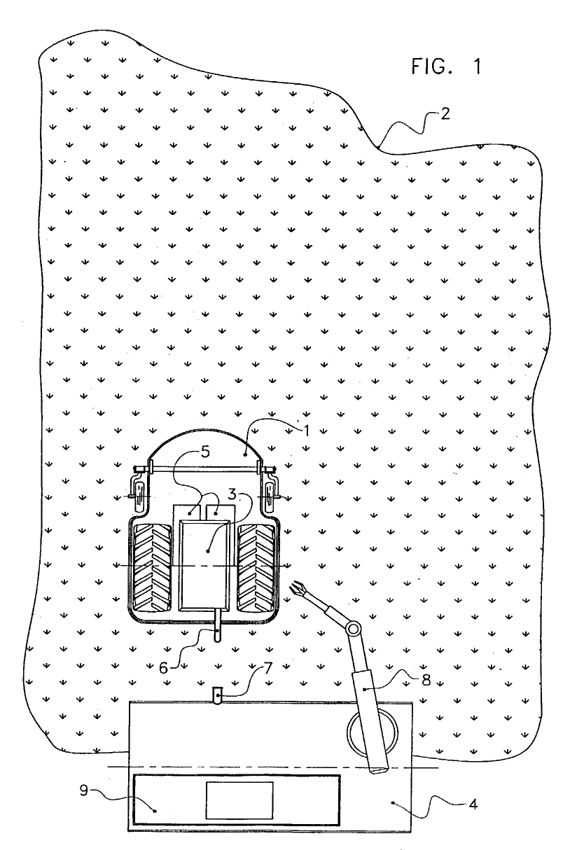

FIG. 1 shows schematically in plan view an autonomous harvesting machine 1 in an agricultural parcel 2 according to an embodiment of the invention. It is pointed out here that an autonomously movable machine, i.e. a machine that does not require a driver for being moved, is known per se and will not be set out here in further detail for the sake of simplicity of the description. Such an autonomous machine may for instance be of the type described in U.S. Pat. No. 4,769,700 the contents of which are hereby incorporated by reference in their entirety.

Various aspects of an autonomous machine are also disclosed in co-pending U.S. patent applications: Ser. No. ______ â [symbol] â [symbol] entitled “An Agricultural Machine for Performing an Agricultural Operation”; Ser. No. ______ â [symbol] â [symbol] entitled “An Agricultural Machine for Performing Crop Processing”; Ser. No. ______ â [symbol] â [symbol] entitled “An Autonomous Agricultural Machine for Performing an Agricultural Operation, in Particular Crop Processing”; Ser. No. ______ â [symbol] â [symbol] entitled “A Device for Crop Processing”; Ser. No. ______ â [symbol] â [symbol] entitled “A System for and a Method of Performing a First and a Second Agricultural Operation on an Agricultural Parcel”; Ser. No. ______ â [symbol] â [symbol] entitled “An Assembly for Performing an Agricultural Operation, in Particular Crop Processing”; Ser. No. ______ â [symbol] â [symbol] entitled “An Agricultural Machine for Performing an Agricultural Operation, in Particular Crop Processing” and Ser. No. ______ â [symbol] â [symbol] entitled “An Assembly and an Autonomous Agricultural Machine for Performing an Agricultural Operation, in Particular Crop Processing”, all of which claim priority in the Netherlands on Jun. 6, 2002, the contents of all of which are hereby incorporated by reference in their entirety.

The autonomous harvesting machine 1 is suitable for performing a harvesting operation on the agricultural parcel 2 and comprises for this purpose for example a crop pick-up device and/or a mowing unit, which are known per se.

The harvesting machine 1 comprises a machine container 3 for containing a harvested product (for example grass). The autonomous harvesting machine 1 further comprises a route information system (not shown) known per se and provided with a memory for containing position data with respect to the agricultural parcel 2. In particular the position of a harvest container 4 that is capable of containing a relatively large amount of harvested product, is stored in the memory. Said data may be stored for example in the form of a ground plan. The route information system further comprises a position-determining device (not shown) known per se for determining the position of the autonomous harvesting machine 1 in the agricultural parcel 2 by means of for example a GPS system. Other well known positioning systems may also be used including DGPS, Galileo, or position determination by means of beacons and the like. Thus it is possible for the control unit of the autonomous harvesting machine 1 to move the harvesting machine 1 to the harvest container 4 with the aid of data from the route information system, taking the amount of harvested product that is present in machine container 3, as measured for example by a weighing device 5 or another measuring device, into account. By this means it is possible to take into account the amount of product which will be harvested on the route to the harvest container 4.

In the embodiment shown the harvesting machine 1 comprises a mechanical protrusion 6 that pushes against a pressure mechanism 7 of the harvest container 4 when the harvesting machine 1 has been moved by the control unit to the harvest container 4. Subsequently, by a mechanical operation, the harvested product can be taken from the machine container 3. Here may be used for example a gripper 8 that takes the amount of harvested product from the machine container or takes the entire machine container (in this case a removable machine container) from the harvesting machine. Various alternative conveying devices may be considered for the conveying the harvested product from the machine container to the harvest container. Such conveying devices may include robot arms, hydraulic rams, conveyer belts, pneumatic or air cushion devices, tipping devices and any other apparatus suitable for performing such an exchange. The transfer may also take place by hand in a conventional way.

When the stock in the harvest container 4 has reached a particular level, measured for example by a measuring device such as a weighing device, a corresponding signal can be transmitted, for example by telephone, by the measuring device to the owner of the parcel or other parties concerned. Apart from this, the signal can activate a processing device 9, for example a baler, a chopper, a drier or the like.

Although the invention has been described with reference to an autonomous harvesting machine that transports a harvested product to the harvest container, it will be obvious that making a harvested product ready for transport and/or for storage can also be performed by another transport machine or the like. The harvesting machine may in particular be an autonomous baler (in which case air is removed from the bales, if desired) or a chopper, which are known per se. In the context of the present invention, a baler may be any device which bundles or packs the crop into a bale or package. A chopper is understood in this context to be a device which chops previously cut crop or vegetable matter into small pieces.

Many modifications in addition to those described above may be made to the structures and techniques described herein without departing from the spirit and scope of the invention. In particular, the devices and methods disclosed herein may also be used in conjunction with further features of the above-referenced co-pending applications. Accordingly, although specific embodiments have been described, these are examples only and are not limiting upon the scope of the invention.

1. An assembly for performing a crop harvesting operation, the assembly comprising:
an autonomous harvesting machine that is movable over an agricultural parcel for performing the crop harvesting operation, the harvesting machine comprising a machine container for containing a first amount of a harvested product;
a measuring device for measuring the first amount of harvested product in the machine container;
a harvest container for receiving the harvested product; and a control unit for automatically moving the harvesting machine to the harvest container with the aid of data from the measuring device.

2. The assembly as claimed in claim 1, wherein the control unit is provided with a route information system for containing route information about a route to the harvest container.

3. The assembly as claimed in claim 1, wherein the assembly further comprises a position-determining system for determining the momentary position of the harvesting machine.

4. The assembly as claimed in claim 1, wherein the assembly further comprises a harvest measuring device for measuring the amount of product in the harvest container.

5. The assembly as claimed in claim 1, wherein the assembly further comprises a processing device for processing the harvested product present in the harvest container.

6. The assembly as claimed in claim 4, wherein the assembly further comprises a processing device for processing the harvested product present in the harvest container.

7. The assembly as claimed in claim 6, wherein the processing device is activated with the aid of data from the harvest measuring device.

8. The assembly as claimed in claim 1, wherein the harvesting machine comprises a crop pick-up device.

9. The assembly as claimed in claim 1, wherein the harvesting machine comprises a mowing unit.

10. The assembly as claimed in claim 1, wherein the harvesting machine is an autonomous baler.

11. The assembly as claimed in claim 1, wherein the harvesting machine is an autonomous chopper.

12. The assembly as claimed in claim 2, wherein the control unit automatically moves the harvesting machine to the harvest container with the aid of data from the measuring device and the route information system taking into account an amount of product to be harvested on the route to the harvest container.

13. The assembly as claimed in claim 12, wherein the harvesting machine comprises a crop pick-up device.

14. The assembly as claimed in claim 12, wherein the harvesting machine comprises a mowing unit.

15. The assembly as claimed in claim 12, wherein the harvesting machine is an autonomous baler.

16. The assembly as claimed in claim 12, wherein the harvesting machine is an autonomous chopper.

17. A device for baling, wherein the device is an autonomous baler that is movable over an agricultural parcel.

18. A device for chopping crop, wherein the device is an autonomous chopper that is movable over an agricultural parcel.
